(19) United States
(12) Patent Application Publication
(10) Pub. No.: US 2008/0155296 A1
(43) Pub. Date: Jun. 26, 2008

(54) Apparatus for controlling clock signals to processor circuit

(75) Inventors: Michael James, Longmont, CO (US); Bradford C. Lincoln, Boulder, CO (US); Jason Molgaard, Windsor, CO (US)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/644,052

(22) Filed: Dec. 22, 2006

(51) Int. Cl. G06F 1/00

(52) U.S. Cl. 713/500

(57) ABSTRACT

Apparatus for controlling input clock signals to a microprocessor includes a clock generator for generating the input clock signals to the microprocessor, and a clock controller for producing a control signal for disabling the clock generator from outputting the input clock signals to the microprocessor for a predetermined time. The clock generator resumes outputting the input clock signals to the microprocessor after the predetermined time.

### FIELD OF INVENTION

The present invention relates to processors, and in particular, to a controller for controlling clock signals supplied to a processor.

### BACKGROUND OF THE INVENTION

Reducing power used by microcontrollers or microprocessors is often a consideration for those in the field of processor circuit design. A typical microprocessor includes thousands of flip-flops that are connected in a network to a single clock source. A relatively significant amount of power is consumed in supplying the clock signals to the microprocessors, because the clock signals must charge and discharge the clock network itself, and also the capacitive load of all the flip-flop clock inputs.

One known approach to reducing power used by a microprocessor is to periodically mask clocks signals going into the microprocessor circuit. For example, three consecutive clocks signals would be masked so that only the fourth clock signal would be sent to the circuit. This approach is typically implemented through hardware. A problem associated with this approach is that it does not work if operational conditions change and one or more of the masked clock signals is required by the circuit. Hardware circuits cannot be easily reconfigured to adapt to the changed conditions.

### SUMMARY OF THE INVENTION

The present invention is directed to an apparatus and method for controlling input clock signals to a microprocessor. The apparatus includes a clock generator for generating the input clock signals to the microprocessor, and a clock controller for producing a control signal for disabling the clock generator from outputting the input clock signals to the microprocessor for a predetermined time. The clock generator resumes outputting the input clock signals to the microprocessor after the predetermined time.

### BRIEF DESCRIPTION OF THE DRAWINGS

FIG. 1 is a block diagram of a clock control system for controlling clock signals to a microprocessor in accordance with one embodiment of the present invention;

FIG. 2 is a block diagram of a processor clock generator in the clock control system of FIG. 1; and

FIG. 3 is a flowchart describing the operation of the clock control system of FIG. 1.

### DETAILED DESCRIPTION OF THE PREFERRED EMBODIMENTS

Broadly stated, the present invention relates to a clock control system for a microprocessor in devices such as disk drives, network interface controllers and storage network switches. The clock control system of the present invention prevents device clock signals from being input to the microprocessor for a predetermined time period while another component of the device performs its operation and the microprocessor waits for the operation to be completed. In this manner, the power required for supplying the clock signals to the microprocessor is reduced.

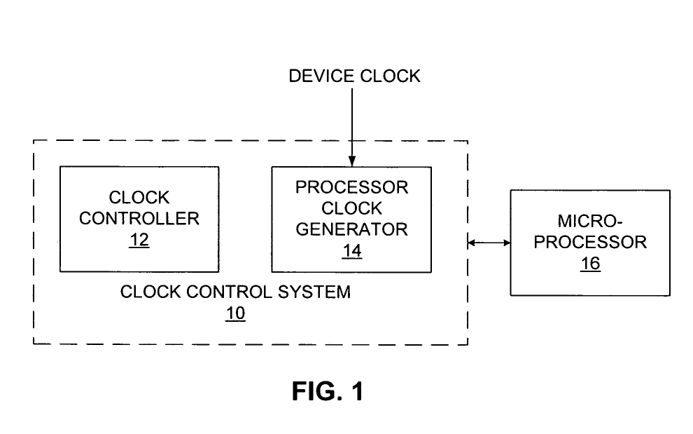

Turning now to FIG. 1, and in accordance with one embodiment of the present invention, a clock control system 10 for controlling device clock signals to a microprocessor includes a clock controller 12 and a processor clock generator 14. The clock controller 12 is programmed to generate a control signal to the processor clock generator 14 at a programmed time. The processor clock generator 14 is adapted to receive the control signal generated by the clock controller 12 and the clock signals received from a device in which the clock control system 10 is implemented, and based on these signals, output or stop clock signals to a microprocessor 16 in the device.

The clock control system 10 and the processor 16 may be implemented in devices such as, for example, disk drives, network interface controllers and storage network switches. The clock control system 10 and the microprocessor 16 may also be incorporated in any devices that employ application specific microprocessors in addition to having a main processor, or in devices that are in communication with a host device that has a main processor for performing functions not handled by an application specific microprocessor. The microprocessor or microcontroller 16 of the present invention is preferably an application specific processor (ASP) for performing its designed operations based on the clock signals received from the processor clock generator 14.

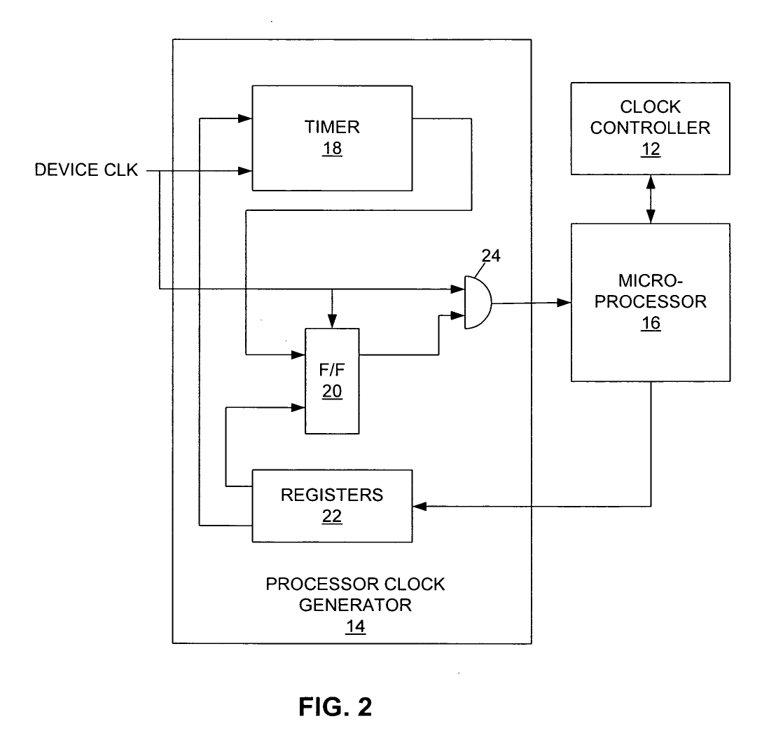

Turning now to FIG. 2, the clock controller 12 is preferably implemented in firmware and is adapted to be run on the microprocessor 16. The processor clock generator 14 includes a timer 18, a flip-flop (F/F) 20, system registers 22 and an AND gate 24. These components of the clock control system 10 operate to prevent the device clock signals from being input to the microprocessor 16 for a predetermined time period, thereby saving power that would otherwise be required in continually supplying clock signals to the microprocessor.

To begin the predetermined time period when no clock signals are input to the microprocessor 16, the registers 22 output a control signal to clear the F/F 20. This causes the F/F 20 to output a “0” to the AND gate 24 and prevent any device clock signals from arriving at the microprocessor 16. When the timer 18 expires at the predetermined time period, the timer 18 outputs a control signal to set the F/F 20, which then outputs a “1” to the AND gate 24, and allows the device clock signals to pass through to the microprocessor 16. The control signals output by the registers 22 to clear the F/F 20 and to set the predetermined time on the timer 18 are written to the registers by the clock controller 12, via the microprocessor 16, or by the microprocessor action alone, as described in more detail below.

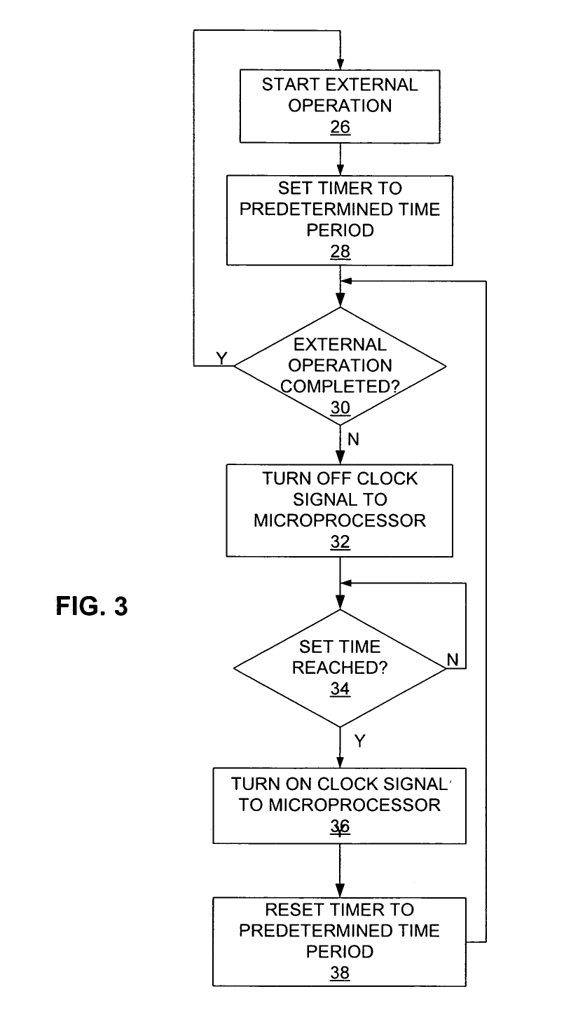

Referring now to FIG. 3, the operation of the clock control system 10 in accordance with one embodiment of the invention is described. When the device in which the microprocessor 16 is implemented requires an operation such as, for example, waiting for a new command to arrive or for the disk drive to complete a seek operation, the clock controller 12, via the microprocessor, outputs a signal to the device component that performs these operations to start an external operation (block 26).

The clock controller 12 then sets the timer 18 to a predetermined time period in which the device clock signal to the microprocessor 16 should be withheld (block 28). More specifically, the instructions for setting predetermined time period would be output by the microprocessor 16 to the registers 22 in accordance with the instructions from the clock controller 12 running on the microprocessor. The registers 22 would then output this information to the timer 18.

Once the timer 18 has been set, the clock controller 12, via the microprocessor 16, checks to see whether the external operation has been completed (block 30). If the external operation has not been completed, the clock controller 12, via the microprocessor 16, turns off the device clock signal to the microprocessor (block 32). In other words, the microprocessor 16 sends a signal to the system registers 22 to output a control signal to clear the F/F 20. This causes the F/F 20 to output a “0” to the AND gate 24 and prevent any device clock signals from arriving at the microprocessor 16.

After set time period has expired, the timer 18 outputs a signal to enable the microprocessor 16 to once again receive the device clock signals (block 36). Specifically, the timer 18 outputs a signal to the F/F 20, which outputs a signal (“1”) to the AND gate 24. The AND gate 24 in turn outputs the device clock signal to the microprocessor 16 when both the device clock signal and the signal from the F/F 20 are high. If, on the other hand, the set time has not expired, the processor clock generator 14 waits for the set time to expire.

After the device clock signal to the microprocessor 16 has resumed, the timer 18 automatically resets itself to the predetermined time period dictated by the clock controller 12 (block 38). The process then goes back to block 30, where the microprocessor 16 determines whether the external operation has been completed. If the external operation has not been completed, the process described above in blocks 32-38 is repeated. If, however, the external operation has been completed, the process goes back to block 26 where the microprocessor 16 starts another external operation.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. Apparatus for controlling input clock signals to a microprocessor provided in a device having a device clock, comprising:
a clock generator for generating the input clock signals to the microprocessor; and
a clock controller for producing a control signal for disabling said clock generator from outputting the input clock signals to the microprocessor for a predetermined time;
wherein said clock generator outputs the input clock signals to the microprocessor after said predetermined time.

2. The apparatus as defined in claim 1, wherein said clock generator generates the input clock signals from device clock signals received from the device clock.

3. The apparatus as defined in claim 2, wherein said clock generator comprises a timer for enabling said clock generator to output the input clock signals after said predetermined time.

4. The apparatus as defined in claim 3, wherein said clock generator comprises:
flip-flops for disabling and enabling the device clock signals from being and to be output to the microprocessor as the input clock signals; and
registers for receiving said control signal, and setting said flip-flop for disabling the device clock signals and said timer to said predetermined time.

5. The apparatus as defined in claim 1, wherein said clock controller is implemented in firmware adapted to be run on the microprocessor.

6. The apparatus as defined in claim 5, wherein said control signal is output to said clock generator by the microprocessor.

7. A method for controlling input clock signals to a microprocessor in a device having a device clock, comprising:
starting one external operation performed by the device;
disabling a clock generator from generating the input clock signals to the microprocessor for a predetermined time while the device is performing the external operation; and
enabling the clock generator to output the input clock signals to the microprocessor after an elapse of the predetermined time.

8. The method as defined in claim 7, wherein said clock generator generates the input clock signals from device clock signals received from the device clock, and said disabling of the clock generator comprises preventing the received device clock signals from being output to the microprocessor.

9. The method as defined in claim 7, wherein the clock generator comprises a timer for enabling said clock generator to output the input clock signals after said predetermined time.

10. The method as defined in claim 7, wherein said disabling of the clock generator from outputting the input clock signals comprises inputting a control signal to the clock generator from a clock controller.

11. The method as defined in claim 10, wherein the clock controller is implemented in firmware adapted to be run on the microprocessor.

12. The method as defined in claim 11, wherein the control signal is output to the clock generator by the microprocessor.

13. The method as defined in claim 7, further comprising checking whether the one external operation is completed prior to disabling the clock generator, and starting another external operation without disabling the clock generator if the one external operation is completed.

14. The method as defined in claim 13, further comprising setting a timer to the predetermined time prior to checking whether the one external operation is completed, and resetting the timer to the predetermined time after enabling the clock generator to output the input clock signals to the microprocessor after an elapse of the predetermined time.

15. A method for reducing power consumed by a microprocessor in a device having a device clock, comprising:
starting an external operation performed by the device;
disabling a clock generator from generating the input clock signals to the microprocessor for a predetermined time while the device is performing an external operation; and
enabling the clock generator to output the input clock signals to the microprocessor after an elapse of the predetermined time.

16. The method as defined in claim 15, further comprising checking whether the one external operation is completed prior to disabling the clock generator, and starting another external operation without disabling the clock generator if the one external operation is completed.

17. The method as defined in claim 16, further comprising setting a timer to the predetermined time prior to checking whether the one external operation is completed, and resetting the timer to the predetermined time after enabling the clock generator to output the input clock signals to the microprocessor after an elapse of the predetermined time.

18. The method as defined in claim 15, wherein said disabling of the clock generator from outputting the input clock signals comprises inputting a control signal to the clock generator from a clock controller implemented in firmware and adapted to be run on the microprocessor.

19. The method as defined in claim 18, wherein the clock generator generates the input clock signals from device clock signals received from the device clock, and the control signal prevents the received device clock signals from being output to the microprocessor as the input clock signals.
